(19) United States
(12) Patent Application Publication
(10) Pub. No.: US 2004/0028596 A1
(43) Pub. Date: Feb. 12, 2004

(54) Nitrogen dioxide, nitrogen oxide and nitric acid manufacture: Kleiner method

(76) Inventor: Bela Kleiner, New York, NY (US)

Correspondence Address: BELA KLEINER, 2705 KINGS HIGHWAY 3D, BROOKLYN, NY, 11229, US

(21) Appl. No.: 10/216,954

(22) Filed: Aug. 12, 2002

(51) Int. Cl. C01B 21/20

(52) U.S. Cl. 423/400

(57) ABSTRACT

In this invention a new chemical process is established and a system designed to produce those compounds according to the process that is part of this invention. In this chemical system, chemical reactions take place at two places when the reactants are in liquid forms; one sort of chemical reactions take place on the surface of the solution pool and another sort of chemical reactions in the solution medium. From the surface reactions the system produces gases; nitrogen dioxide, nitrogen oxide and water; in the deep, in the solution medium, the system produces solid(s), liquid and gases. The solid(s) may be inorganic salt(s) or organometallic salt(s), and sometimes solid element(s), as iodine, for example. For the liquid it will be nitric acid and water, for the gas, it will be nitrogen oxide, for the solid can be different salt(s), depend on the chemical reaction design.

In liquid phase on the surface of the liquid, chemical reactions take place that produce nitrogen dioxide and nitrogen oxide in the ratio 1:1 or so. Nitrogen dioxide, nitrogen oxide and nitric acid laboratory and industrial manufacture the new way.

Sodium or potassium nitrite about 42% concentration in water, but also in any percentage concentration, in surface contact with concentrated, but in lesser concentration also, mineral—as well as organic acids produce nitrogen dioxide and nitrogen oxide on the surface of the salt solution. In the liquid phase, in the liquid, the chemical reactions give mineral (inorganic) or organic salt(s) as well as nitric acid to certain amount, and also under certain condition nitrous acid, but that compound does not last long. The mineral acids that give good results are sulfuric acid, nitric acid, hydrochloric acid, hydrobromic acid, hydrofluoric acid, hydriodic acid, phosphoric acid and iodine monochloride as well as bromine. Among the organic acids the best result can be achieved with formic acid, acetic acid, propionic and butyric acid. The surface reactions go, probably, fastest with sulfuric acid; the chemical reactions go fast with nitric acid, with hydrofluoric acid, with hydriodic acid, with phosphoric acid, with hydrochloric acid, with hydrobromic acid, with bromine. The reactions with the organic acids go fastest with formic acid, second fastest with acetic acid, slow with propionic and butyric acid. The reactions happen with lactic acid too, however, very, very slow. In the liquid phase NO₂, NO gases are still produced, however, nitrogen dioxide gas dissolves into water and forms nitric acid there; under certain condition can form nitrous acid too. The larger the surface area contact between the reactants, the better the result of the gas mixture. These same reactions can be carried out with the nitrite salt(s) in solid form and the acids in liquid form, the surface reactions result in nitrogen dioxide and nitrogen oxide gases formation, however, this procedure presently, only on a small scale is this approach suitable, because the secondary product(s) from the chemical reactions is solid, so it deposits onto the reactants, thus hinders the reaction process, also in the use of the solid form one of the nitrite salts to penatrate deep into the solid layer, it needs more acid that is not very efficient approach; nitric acid as the secondary product still will form in lesser or in larger amount depends on the second reactant, the acid that is used. In a way this can be a design system to produce nitric acid or nitrogen dioxide or nitrogen oxide or both with different secondary products, almost as one desires. Iodine monochloride and liquid bromine can be used as second reactant(s) to produce nitrogen dioxide, nitrogen oxide and the secondary products that are similar to the secondary products obtained with the inorganic- or organic acids. These chemical reactions may be new, important discoveries. In this system the reactants are used in stoichiometric ratio.

This process; my invention to manufacture nitrogen dioxide, nitrogen oxide and nitric acid Kleiner method. The major chemical reactions what my new system is concerned with, in large extent, take place on the surface of the water medium and produce two different gases; namely nitrogen dioxide and nitrogen oxide. In the deeper layer of the water medium, chemical reactions also take place, those chemical reactions produce nitric acid, nitrogen oxide and mineral- or organic salt(s). The nitric acid and the salt(s) formed by the chemical process, remain partially or wholly dissolved in the liquid.

The chemical reactions take place in the reaction vessel at room temperature, where, on large surface area about 42% concentration (by weight) in water sodimum nitrite or potassium nitrite is loaded into the reaction vessel to form shallow pool of the solution with fairly large surface area. The system preferably should be under vacuum, however, it is not essential. The reactions still will take place whether the system is evacuated of air or not. The reactions start at room temperature. The reactions in the reaction vessel are exothermic and they go fast, fairly fast or slow depend on what acid or acids are choosen to run the reactions with, what concentration of the acid or the salt solution is used. The higher the concentration of the salt solution as well as the acid or acids solutions, the faster the reactions. In instances good results can be achieved using the salt as solid and acid as liquid, however, this approach can successfully be used only on small scale. For the solid form use of nitrite salt(s) in this process on large (industrial) scale, the technological difficulties are not solved yet. The first reactant in my invention is the nitrite salt(s); the higher the concentration, the faster the reactions will go. The second reactant in my process one can choose among inorganic acids, organic acids, combination of halide liquids like iodine monochloride, iodine monobromide, bromine. One can use only one or one may choose two, depend on how fast one wants the reactions to be going or what the secondary product or products one wants harvest from the system. On the industrial scale as well as on the small scale, let's say, at the beginning, the best result can be achieved with the inorganic acids, sulfuric acid, nitric acid, hydrochloric acid, hydrobromic acid, phosphoric acid, bromine. Among the organic acids, the best results can be achieved with formic acid, acetic acid and propionic acid. When one works with the nitrite salt solution or one may prefer nitrite salts solution (NaNO₂+KNO₂), the chemical reactions go fastest when the acid is at its maximum concentration.

When this process is uses inorganic acid, the chemical reactions probably go fastest with sulfuric acid, go fast with nitric acid, with hydrofluoric acid, with hydrochloric acid, with hydrobromic acid, with hydriodic acid, with phosphoric acid, with bromine. The reactions with the iodine monochloride is also fast enough, but because it deposits solid iodine in the medium, it slows down considerably. It seems to me because in hydrochloric acid is too much water that makes the reactions go much slower. In the process of my invention, the chemical reactions with organic acids go fastest with formic acid, second fastest with acetic acid and yet slower with propionic acid, butyric acid and very slow with lactic acid.

In my invention on the surface of the nitrite solution pool, and in the solution medium the following chemical reactions are taking place:

1. when sulfuric acid (H₂SO₄) is used as the second reactant:

(a) on the surface on the solution pool

(a1) 2NaNO₂(aq)+H₂SO₄(l)→NO₂(g)+NO(g)+Na₂SO₄(aq)+H₂O(l) (1A1)

(a2) 2KNO₂(aq)+H₂SO₄(l)→NO₂(g)+NO(g)+K₂SO₄(aq)+H₂O(l) (1A2)

here the gases collect above the surface of the solution.

(b). in the liquid phase of the salt solution

(b1) 2NaNO₂(aq)+H₂SO₄(l)→NO₂(g)+NO(g)+Na₂SO₄(aq)+H₂O(l)3NO₂(g)+H₂(l)→2HNO₃(aq)+NO(g) (1B1)

(b2) 2KNO₂(aq)+H₂SO₄(l)→NO₂(g)+NO(g)K₂SO₄(aq)+H₂O(l)3NO₂(g)+H₂O(l)→2HNO₃(aq)NO(g) (1B2)

In the liquid phase, the nitrogen dioxide formed immediately reacts with water and thus converts into nitric acid and nitrogen oxide.

2. when nitric acid (HNO₃) is used as the second reactant:

(a) on the surface of the solution pool

(a1) 2NaNO₂(aq)+2HNO₃(l)→NO₂(g)+NO(g)+2NaNO₃(aq)+H₂O(l) (2A1)

(a2) 2KNO₂(aq)+2HNO₃(l)→NO₂(g)+NO(g)+2KNO₃(aq)+H₂O(l) (2A2)

(b) in the liquid phase of the salt solution

(b1) 2NaNO₂(aq)+2HNO₃(l)→NO₂(g)+NO(g)+2NaNO₃(aq)+H₂O(l)3NO₂(g)+H₂O(l)→2HNO₃(aq)+NO(g) (2B1)

(b2) 2KNO₃(aq)+2HNO₃(l)→NO₂(g)+NO(g)+2KNO₃(aq)+H₂O(l)3NO₂(g)+H₂O(l)→2HNO₃(aq)+NO(g) (2B2)

3. when phosphoric acid (H₃PO₄) is used as the second reactant:

(a) on the surface of the solution pool

(a1) 6NaNO₂(aq)+2H₃PO₄(l)→3NO₂(g)+3NO(g)+2Na₃PO₄(aq)+3H₂O(l) (3A1)

(a2) 6KNO₂(aq)+2H₃PO₄(l)→3NO₂(g)+3NO(g)+2K₃PO₄(aq)+3H₂O(l) (3A2)

(b) in the liquid phase of the salt solution

(b1) 6NaNO₂(aq)+2H₃PO₄(l)→3NO₂(g)+3NO(g)+2Na₃PO₄(aq)+3H₂O(l)3NO₂(g)+H₂O(l)→2HNO₃(aq)+NO(g) (3A1)

(b2) 6KNO₃(aq)+2H₃PO₄(l)→3NO₂(g)+3NO(g)+2K₃PO₄(aq)+3H₂O(l)3NO₂(g)+H₂O(l)→2HNO₃(aq)+NO(g) (3B2)

4. when hydrochloric acid (HCl) is used as the second reactant:

(a) on the surface of the solution pool

(a1) 2NaNO₂(aq)+2HCl(l)→NO₂(g)+NO(g)+2NaCl(aq)+H₂O(l) (4A1)

2KNO₂(aq)2HCl(l)→NO₂(g)+NO(g)+2KCl(aq)+H₂O(l) (4A2)

(b) in the liquid phase of the salt solution

(b1) 2NaNO₂(aq)+2HCl(l)→NO₂(g)+NO(g)+2NaCl(aq)+H₂O(l)3NO₂(aq)+H₂O(l)→2HNO₃(aq)+NO(g) (4B1)

(b2) 2KNO₂(aq)+2HCl(l)→NO₂(g)+NO(g)+2NaCl(aq)+H₂O(l)3NO₂(g)+H₂O(l)→2HNO₃(aq)+NO(g) (4B2)

5. when hydrobromic acid is used as second reactant:

(a) on the surface of the solution pool

(a1) 2NaNO₂(aq)+2HBr(l)→NO₂(g)+NO(g)+2NaBr(aq)+H₂O(l) (5A1)

(a2) 2KNO₂(g)+2HBr(l)→NO₂(g)+NO(g)+2KBr(aq)+H₂O(l) (5A2)

(b) in the liquid phase of the salt solution

(b1) 2NaNO₂(aq)+2HBr(l)→NO₂(g)+NO(g)+2KBr(aq)+H₂O(l)3NO₂(g)+H₂O(l)→2HNO₃(aq)+NO(g) (5B1)

When in this process the second reactant is hydrobromic acid, and the chemical reaction are complete, and the solution in the reaction vessel is left standing for a period of time, bromine will form and it dissolves in the solution coloring it yellow. These chemical reactions are not understood yet well, besides bromine, sodium- or potassium nitrate may form as well.

6. when iodine monochloride is used as the second reactant:

(a) on the surface of the solution pool

(a1) 2NaNO₂(aq)+2ICl(l)→NO₂(g)+NO(g)+NaOCl(aq)+NaCl+I₂(s)+H₂O(l) (6A1)

(a2) 2KNO₂(aq)+2ICl(l)→NO₂(g)+NO(g)+KOCl(aq)+KCl(aq)+H₂O(l)+I₂(s) (6A2)

(b) in the liquid phase of the salt solution

(b1) 2NaNO₂(aq)+2ICl(l)→NO₂(g)+NO(g)+NaOCl(aq)+NaCl(aq)+I₂(s)+H₂O(l)3NO₂(g)+H₂O(l)→2HNO₃(aq)+NO(g) (6B1)

in the liquid phase the reaction may be a little more complicated, however, the main products can be recognized namely NO₂, NO, I₂.

(b2) 2KNO₂(aq)+2ICl(l)→NO₂(g)+NO(g)+KOCl(aq)+KCl(aq)+H₂O(l)+I₂(s)3NO₂(g)+H₂O(l)→2HNO₃(aq)+NO(g) (6B2)

The reactions with the organic acids will go as the following:

7. when formic acid (HCOOH)is used as the second reactant:

(a) on the surface of the solution pool

(a1) 2NaNO₂(aq)+2HCOOH(l)→NO₂(g)+NO(g)+2HCOONa(aq)+H₂O(l) (7A1)

(a2) 2KNO₂(aq)+2HCOOH(l)→NO₂(g)+NO(g)+2HCOOK(aq)+H₂O(l) (7A2)

(b) in the liquid phase of the salt solution

(b1) 2NaNO₂(aq)+2HCOOH(aq)→NO₂(g)+NO(g)+2HCOONa(aq)+H₂O(l)3NO₂(g)+H₂O(l)→2HNO₃(aq)+NO(g) (7B1)

(b2) 2KNO₂(aq)+2HCOOH(l)→NO₂(g)+NO(g)+2HCOOK(aq)+H₂O(l)3NO₂(g)+H₂O(l)→2HNO₃(aq)+NO(g) (7B2)

8. when acetic acid (CH₃COOH) is used as the second reactant:

(a) on the surface of the solution pool

(a1) 2NaNO₂(aq)+2CH₃COOH(l)→NO₂(g)+NO(g)+2CH₃COONa(aq)+H₂O(l) (8A1)

(a2) 2KNO₂(aq)+2CH₃COOH(l)→NO₂(g)+NO(g)+2CH₃CH₂COOK(aq)+H₂O(l) (8A2)

(b) in the liquid phase of the salt solution

(b1) 2NaNO₂(aq)+2CH₃COOH(l)→NO₂(g)+NO(g)+2CH₃COONa(aq)+H₂O(l)3NO₂(g)+H₂O(l)→2HNO₃(aq)+NO(g) (8B1)

(b2) 2KNO₂(aq)+2CH₃COOH(l)→NO₂(g)+NO(g)+2CH₃COOK(aq)+H₂O(l)3NO₂(g)+H₂O(l)→2HNO₃(aq)+NO(g) (8B2)

9. when propionic acid (CH₃CH₂COOH) is used as the second reactant:

(a) on the surface of the solution pool

(a1) 2NaNO₂(aq)+2CH₃CH₂COOH(l)→NO₂(g)+NO(g)+2CH₃CH₂COONa(aq)+H₂O(l) (9A1)

(a2) 2KNO₂(aq)+2CH₃CH₂COOH(l)→NO₂(g)+NO(g)+2CH₃CH₂COOK(aq)+H₂O(l) (9A2)

(b) in the liquid phase of the salt solution

(b1) 2NaNO₂(aq)+2CH₃CH₂COOH(l)→NO₂(g)+NO(g)+2CH₃CH₂COONa(aq)+H₂O(l)3NO₂(g)+H₂O(l)→2HNO₃(aq)+NO(g) (9B1)

(b2) 2KNO₂(aq)+2CH₃CH₂COOH(l)→NO₂(g)+NO(g)+2CH₃CH₂COOK(aq)+H₂O(l)3NO₂(g)+H₂O(l)→2HNO₃(aq)+NO(g) (9B2)

10. when hydriodic acid (HI) is used as the second reactant:

(a) on the surface of the solution pool

(a1) 2NaNO₂(aq)+2HI(l)→NO₂(g)+NO(g)+I₂(s)+H₂O(l)+2NaOH(aq) (10A1)

or

2NaNO₂(aq)2HI(l)→NO₂(g)+NO(g)+I₂(s)+H₂(g)+2NaOH(aq) (10A1a)

(a2) 2KNO₂(aq)+2HI(l)→NO₂(g)+NO(g)+I₂(s)+H₂O(l)+2KOH(aq) (10A2)

or

2KNO₂(aq)+2HI(l)→NO₂(g)+NO(g)+I₂(s)+H₂(g)+2KOH(aq) (10A2a)

(b) in the solution phase:

(b1) 2NaNO₂(aq)+2HI(l)→NO₂(g)+NO(g)+I₂(s)+H₂O(l)+2NaOH(aq)3NO₂(g)+H₂O(l)→2HNO₃(aq)+NO(g) (10B1)

or

2NaNO₂(aq)+2HI(l)→NO₂(g)+NO(g)+I₂(s)+H₂(g)+2NaOH(aq)3NO₂(g)+H₂O(l)→2HNO₃(aq)+NO(g) (10B1a)

(b2) 2KNO₂(aq)+2HI(l)→NO₂(g)+NO(g)+I₂(s)+H₂O(l)+2KOH(aq)3NO₂(g)+H₂O(l)→2HNO₃(aq)+NO(g) (10B2)

or

(2ba) 2KNO₂(aq)+HI(l)→NO₂(g)+NO(g)+I₂(s)+H₂(g)+2KOH(aq)3NO₂(g)+H₂O(l)→2HNO₃(aq)+NO(g) (10B2a)

11. when bromine (Br₂) is used as the second reactant:

(a) on the surface of the solution pool the chemical reactions may go either as follow:

2NaNO₂(aq)+Br₂(l)→NO₂(g)+NO(g)+BrO⁻(aq)+NaBr(aq)+Na⁺BrO⁻(aq)+Na⁺+H₂O(l)→HOBr(aq)+NaOH(aq) HOBr(aq)+NaOH(aq)→NaBr(aq)+2OH⁻ (11A1)

thus the over all reactions may be as follow:

2NaNO₂(aq)+Br₂(aq)→NO₂(g)+NO(g)+2NaBr(aq)+2OH⁻ (11A1a)

2KNO₂(aq)+Br₂(l)→NO₂(g)+NO(g)+2OH⁻+2KBr(aq) (11A2)

(b) in the liquid phase of the salt solution:

2NaNO₂(aq)+Br₂(l)→NO₂(g)+NO(g)+BrO⁻NaBr(aq)+Na⁺BrO⁻+Na⁺+H₂O(l)→HOBr(aq)+NaOH(aq) HOBr(aq)+NaOH(aq)→NaBr(aq)+2OH⁻3NO₂(g)+H₂O(l)→2HNO₃(aq)+NO(g) (11B1)

2KNO₂(aq)+Br₂(l)→NO₂(g)+NO(g)+BrO⁻(aq)+KBr(aq)+K⁺BrO⁻+K⁺+H₂O(l)→HOBr(aq)+KOH(aq) HOBr(aq)+KOH(aq)→KBr(aq)+2OH⁻3NO₂(g)+H₂O(l)→2HNO₃(aq)+NO(g) (11B2)

or the chemical reactions on the surface of the salt solution pool may go as follow:

2NaNO₂(aq)+Br₂(l)→NO₂(g)+NO(g)+2NaBr(aq)+O²⁻O²⁻+H₂)O(l)→2OH⁻2OH⁻+2H₃O⁺+4H₂O(l) (11C1)

2KNO₂(aq)+Br₂(l)→NO₂(g)+NO(g)+2KBr(aq)+O²⁻O²⁻+H₂O(l)→2OH⁻2OH⁻+2H₃O⁺→4H₂O(l) (11C2)

in the liquid phase of the salt solution:

2NaNO₂(aq)+Br₂(l)→NO₂(aq)+NO(g)+2NaBr(aq)+O²⁻O²⁻+H₂O→2OH⁻2OH⁻+2H₃O⁺→4H₂O(l)3NO₂(g)+H₂O(l)→2HNO₃(l)+NO(g) (11D1)

the overall chemical reactions then may go as follow:

2KNO₂(aq)+Br₂(l)→NO₂(g)+NO(g)+2KBr(aq)+2OH⁻3NO₂(g)+H₂O(l)→2HNO₃(aq)+NO(g) (11D2)

Solid nitrite salts chemically react with liquid acids, however, the chemical reactions proceed a little differently and the speed of the chemical reactions here may differ, may go slower than when the nitrite salt(s) is in solution. Solid nitrite salt when reacted with concentrated sulfuric acid, the chemical reactions go very slow and it needs more acid, because the acid has to penatrate the crystals of the salt. Once the chemical reactions go, product, solid sodium sulfate is deposited onto the reaction species, thus further hindering the chemical reactions, the very little water that concentrated sulfuric acid contains can not penatrate the crystals of the nitrite salt, so the reactions naturally will go slow and thus be inefficient. With dilute sulfuric acid, however, things will change. The water medium can penetrate easier the crystal structure of the nitrite salt, making the way for the reactants to come into contact with each other faster, also the water medium can carry away forming sodium sulfate solid from the reaction sites thus enabling the chemical reactions to go faster; sure this way the system will need more acid to produce the desired amount of the gases, and also more nitric acid will be produced as the secondary product. The chemical reactions here will go somewhat different, because the presence of the water will cause the chemical reactions not go only on on the surface of the solution but in the solution phase too. On the surface of the solution the chemical reactions will yield solid sodium sulfate instead of the aqueous sodium sulfate, in the solution phase the same will happen, except maybe at the beginning of the reactions, because at the very beginning the solution will not be saturated yet, the forming product may dissolve there, however, once the solution is saturated, salt formed can not dissolve anymore. These chemical reactions then can be represented as follow:

2NaNO₂(s)+H₂SO₄(l)→NO₂(g)+NO(g)+Na₂ SO₄(s)+H₂O(l)2NaNO₂(aq)+H₂SO₄(l)→NO₂(g)+NO(g)+Na₂SO₄(s)+H₂O(l)3NO₂(g)+H₂O(l)→2HNO₃(aq)+NO(g) (10)

The more water the system contains, the more nitric acid will be produced, because the forming nitrogen dioxide gas can easier dissolve into it, thus forming nitric acid as secondary product.

Solid nitrite salt(s) react also with concentrated nitric acid; again this reaction is slow for the same reason as explained before, however, nitric acid contains little more water than sulfuric acid, so the chemical reactions with solid nitrite salts will go somewhat faster than with sulfuric acid. The chemical reactions may be described as follow:

2NaNO₂(s)+2HNO₃(l)→NO₂(g)+NO(g)+2NaNO₃(s)+H₂O(l)2NaNO₂(aq)+2HNO₃(l)→NO₂(g)+NO(g)+H₂O(l)3NO₂(g)+H₂O(l)→2HNO₃(aq)+NO(g) (11)

With less concetrated nitric acid this reaction may go faster, but not much faster.

Solid nitrite salt(s) react with hydrobromic acid, the reactions go fast. Hydrobromic acid more than 50% is water. The water content in the acid penatrates the crystals of the solid nitrite salt(s), it also dissolves the forming salt product and carries it away from the reaction sites that is why the chemical reactions can proceed faster. Of course after some time the water solution will become saturated, its ability to penatrate and carry will diminish and the chemical reactions naturaly will slow. The chemical reactions of HBr with solid nitrite salts may be written as follow:

2KNO₂(s)+2HBr(l)→NO₂(g)+NO(g)+2KNO₃(aq)H₂O(l)2KNO₂(aq)+2HBr(l)→NO₂(g)+NO(g)+KNO₃(aq)+KNO₃(s)+H₂O(l)3NO₂(g)+H₂O(l)→2HNO₃(aq)+NO(g) (12)

Solid nitrite salt(s) will react with hydrofluoric acid. The chemical reactions go fast; they may be written as follow:

2KNO₂(s)+2HF(l)→NO₂(g)+NO(g)+2KF(aq)+H₂O(l)2KNO₂(aq)+2HF(l)→NO₂(g)+NO(g)+KF(aq)+KF(s)+H₂O(l)3NO₃(g)+H₂O(l)→2HNO₃(aq)+NO(g) (13)

The reaction of solid nitrite salts with hydrochloric acid is also fast. The chemical reactions may be written as follow:

2NaNO₂(s)+2HCl(l)→NO₂(g)+NO(g)+2NaCl(aq)+H₂O(g)2NaNO₂(aq)+2HCl(l)→NO₂(g)+NO(g)+NaCl(aq)+NaCl(s)+H₂O(l)3NO₂(g)+H₂O(l)→2HNO₃(aq)+NO(g) (14)

Solid nitrite salts react also with iodine monochloride when in liquid form; at low temperature iodine monochloride solidifies, in solid form will not react with the nitrite salt(s) but in liquid form, it reacts, however, the reaction is very slow.

Solid nitrite salts react with organic acids too, however, it looks like only the formic acid gives a good result. The chemical reactions with formic acid goes fast and they may be written as follow:

2KNO₂(s)+2HCOOH(l)→NO₂(g)+NO(g)+2 HCOOK(s)+H₂O(g)2KNO₂(aq)+2HCOOH(l)→NO₂+NO(g)+2HCOOK(s)+H₂O(l)3NO₂+H₂O(l)→2HNO₃+NO(g) (15)

Other organic acids will react with solid nitrite salts those reactions are slow whether the acids are concentrated or dilute.

The chemical reactions are started in the reaction vessel by spraying the second reactant(s); the acid(s) on the surface of the shallow, almost saturated, salt pool. The spraying is done with some force, so that the acid drops hit the surface of the pool with some velocity. The nitrite salt solution(s) is about 42% concentration. The reaction starts at room temperature. Some temperature develops during the reaction run. In large scale reaction runs, the temperature of the reaction vessel has to be maintained. When the reaction starts, the liberated gas mixture (nitrogen dioxide and nitrogen oxide) gathers above the surface of the solution and fills the reaction vessel, then the gas mixture drifts over into the gas tank or if the gas-converter is used, the gas mixture is sucked away into the gas converter to allow the least amount of the generated nitrogen dioxide to dissolve into the salt solution. The amount of the second reactant(s) is delivered into the reaction vessel to the amount to try to exhaust the nitrite salt's concentration to the last molecule if possible. The amount of the reactants can be brought together stoichiometrically when the yield of the reaction harvest is not the priority attainment.

In the gas tank the gas mixture which consists of nitrogen dioxide and nitrogen oxide and some impurities can be converted into homogenous nitrogen dioxide by introducing oxygen into the tank. The oxygen will react with the nitrogen oxide to form nitrogen dioxide

2NO(g)+O₂(g)→2NO₂(g) (16)

For this same conversion air also can be used, the oxygen contained in air will react with nitrogen oxide giving nitrogen dioxide.

Now the homogenous nitrogen dioxide in the gas tank can be used as the final product on one hand or it can be transferred into the acid converter there the gas is mixed with water, thus it converts into nitric acid.

In the acid converter the collected and converted nitrogen dioxide gas is bubbled into water; here the NO₂ gas reacts with water forming nitric acid and nitrogen oxide as follow:

3NO₂(g)+H₂O(l)→2HNO₃(aq)+NO(g) (17)

From the acid converter nitrogen oxide gas that has formed there is transferred into the nitrogen-oxide tank and collected there as the final product or it can be recycled back into the system either into the gas tank when the system is designed for the gas tank or into the gas-converter if the system is designed for gas converter. From the acid converter, the row nitric acid solution is transferred into the distilling vessel where the excess water is distilled off, then the concentrated nitric acid goes through a cooler into the nitric acid product tank.

The secondary products from the reaction vessels are transferred into the secondary distilling vessel where the nitric acid formed in the solution phase (not in the surface reactions) is distilled off, the distillate of the nitric acid goes into the condenser where it is cooled and then it goes into the nitric acid solution tank. This nitric acid solution then can be redistilled to recover the nitric acid that had formed in the liquid phase of the ongoing chemical reactions. If the system is designed with the gas converter where the gas mixture of the nitrogen dioxide and nitrogen oxide is drawn away from the reaction vessel can be mixed with oxygen under pressure, thus NO gas converts into nitrogen dioxide and then the process can be employed that has been used at the use of the gas tank.

The remaining material in the secondary distilling vessel is transferred into the settling tank. In the settling tank the salt(s) settle, the liquid is drained, the salt(s) further purified and then collected as useful product(s).

### DRAWING DESCRIPTION

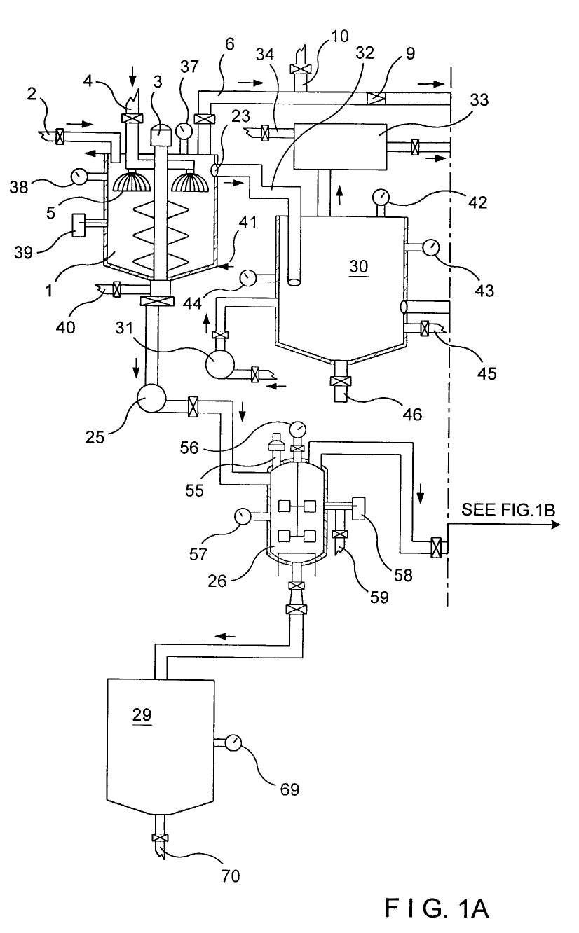

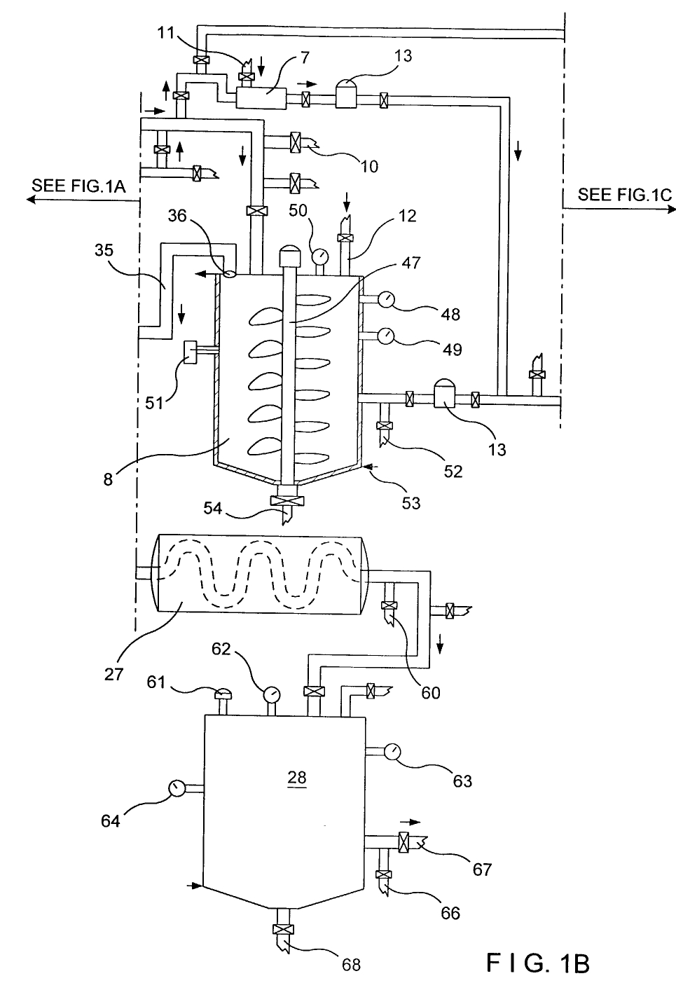

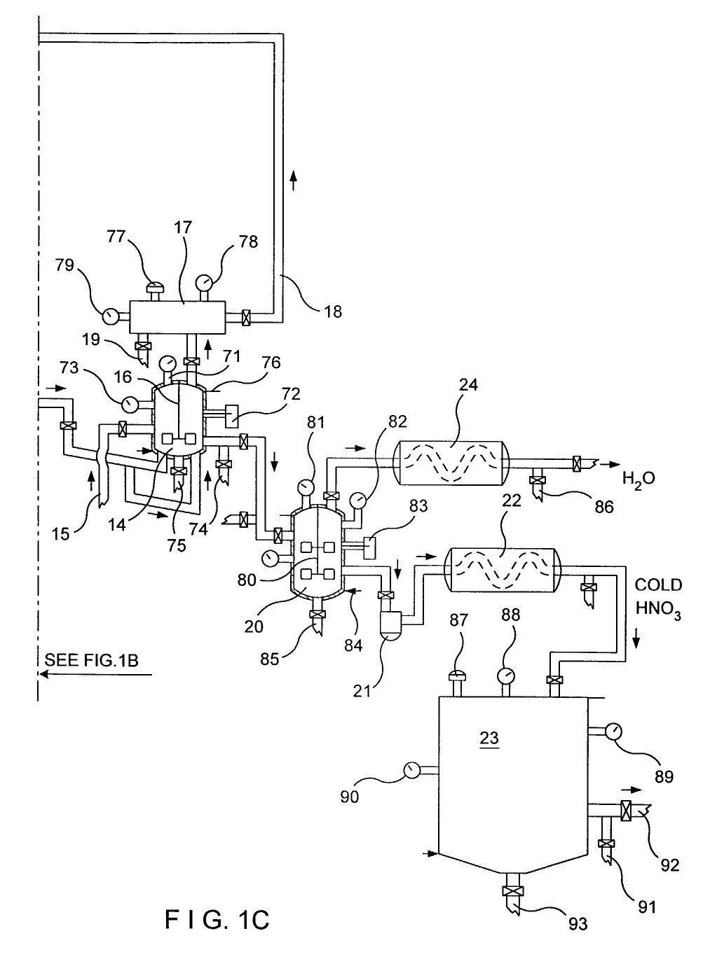

1. Reaction vessel FIG. 1A.

2. Load line FIG. 1A.

3. Mixer FIG. 1A.

4. Acid delivery line FIG. 1A.

5. Acid-shower heads FIG. 1A.

6. Gas-mixture product-line FIG. 1A.

7. Gas converter FIG. 1B.

8. Gas tank FIG. 1B.

9. One-directional valve FIG. 1A.

10. Vacuum line FIG. 1A, FIG. 1B.

11. Oxygen line FIG. 1B.

12. Purging line FIG. 1B.

13. Gas pump FIG. 1B.

14. Acid converter FIG. 1C.

15. Water line FIG. 1C.

16. Mixer of the acid-converter FIG. 1C.

17. Nitrogen oxide tank FIG. 1C.

18. Nitrogen-oxide-recycle line FIG. 1C.

19. Nitrogen oxide gas-outlet FIG. 1C.

20. Distilling vessel FIG. 1C.

21. Nitric acid pump FIG. 1C.

22. Nitric acid cooler FIG. 1C.

23. Nitric acid product tank FIG. 1C.

24. Water cooler FIG. 1C.

25. Secondary product pump FIG. 1A.

26. Secondary distilling vessel FIG. 1A.

27. Secondary water cooler FIG. 1B.

28. Secondary nitric acid solution tank FIG. 1B.

29. Settling tank FIG. 1A.

30. Water tank FIG. 1A.

31. Water pump FIG. 1A.

32. Safety line FIG. 1A.

33a.=23 on the drawing; safety membrane FIG. 1A.

33. Gas safety tank FIG. 1A.

34. Purging line FIG. 1A.

35. Gas tank's safety line FIG. 1B.

36. Safety pressure membrane FIG. 1B.

37. Reaction vessel's pressure control FIG. 1A.

38. Reaction vessel's temperature control FIG. 1A.

39. Reaction vessel's level control FIG. 1A.

40. Reaction vessel's sample valve FIG. 1A.

41. Reaction vessel's water cooler system FIG. 1A.

42. Safety tank pressure control FIG. 1A.

43. Safety tank temperature control FIG. 1A.

44. Safety tank level control FIG. 1A.

45. Safety tank sample line FIG. 1A.

46. Safety tank waste line FIG. 1A.

47. Gas tank mixer FIG. 1B.

48. Gas tank pressure control FIG. 1B.

49. Gas tank temperature control FIG. 1B.

50. Gas tank pressure gage FIG. 1B.

51. Gas tank level control FIG. 1B.

52. Gas tank sample valve FIG. 1B.

53. Gas tank water-cooling FIG. 1B.

54. Gas tank waste line FIG. 1B.

55. Secondary distilling vessel's safety valve FIG. 1A.

56. Secondary distilling vessel's pressure control FIG. 1A.

57. Secondary distilling vessel's temperature control FIG. 1A.

58. Secondary distilling vessel's level control FIG. 1A.

59. Secondary distilling vessel's purging line FIG. 1A.

60. Secondary distilling vessel's sample valve FIG. 1B.

61. Safety valve on the nitric acid solution tank FIG. 1B.

62. Pressure control of the nitric acid solution tank FIG. 1B.

63. Temperature control of the nitric acid solution tank FIG. 1B.

64. Level control of the nitric acid solution tank FIG. 1B.

65. Purging line of the nitric acid solution tank not marked - FIG. 1B.

66. Sample valve of the nitric acid solution tank FIG. 1B.

67. Transfer-line of the nitric acid solution tank FIG. 1B.

68. Waste line of the nitric acid solution tank FIG. 1B.

69. Settling tank's level control FIG. 1A.

70. Settling tank's waste line FIG. 1A.

71. Acid converter's pressure control FIG. 1C.

72. Acid converter's level control FIG. 1C.

73. Acid converter's temperature control FIG. 1C.

74. Acid converter's sample valve FIG. 1C.

75. Acid converter's waste waste line FIG. 1C.

76. Acid converter's water-cooling system FIG. 1C.

77. Nitrogen-oxide tank's safety valve FIG. 1C.

78. Nitrogen-oxide tank's pressure control FIG. 1C.

79. Nitrogen-oxide tank's temperature control FIG. 1C.

80. Distilling vessel's mixer. FIG. 1C.

81. Distilling vessel's pressure control FIG. 1C.

82. Distilling vessel's temperature control FIG. 1C.

83. Distilling vessel's level control FIG. 1C.

84. Distilling vessel's steam line FIG. 1C.

85. Distilling vessel's sample valve and waste line FIG. 1C.

86. Water-cooler's sample valve FIG. 1C.

87. Nitric acid product tank's safety valve FIG. 1C.

88. Nitric acid product tank's pressure control FIG. 1C.

89. Nitric acid product tank's temperature control FIG. 1C.

90. Nitric acid product tank's level control FIG. 1C.

91. Nitric acid product tank's sample valve FIG. 1C.

92. Nitric acid product tank's shipping line FIG. 1C.

93. Nitric acid product tank's waste line FIG. 1C.

1. What I claim as my invention is: a process for production of nitrogen dioxide, nitrogen oxide using solid nitrite salt(s) or nitrite salt(s) solution and liquid acids or liquid halide compounds, and then from the generated gases manufacture nitric acid; the chemicals for the chemical reactions are brought together at room temperature or a little lower or a little higher then the room temperature.

2. What I claim as my invention is: the process in claim 1 using sodium- or potassium nitrite in solid or concentrated solution form(s) are the source; the chemicals brought together with inorganic or organic acid(s) as well as with some halide compounds will generate nitrogen dioxide and nitrogen oxide.

3. What I claim as my invention is: nitrogen dioxide and nitrogen oxide produced in claim 2 is converted into homogeneous nitrogen oxide by introducing oxygen into the gas mixture at room temperature; the NO gas contained in the gas mixture will react with oxygen to form nitrogen dioxide.

4. What I claim as my invention is: the homogeneous nitrogen dioxide from claim 3<can be used as row material to produce nitric acid.

5. What I claim as my invention is: the gas mixture in claim 2 can be bubbled into water, thus the two gases are separated; nitrogen dioxide in the water will form nitric acid, nitrogen oxide is collected and can be used for other purposes.

6. What I claim as my invention is: the collected nitrogen oxide in claim 5 can be reacted with oxygen or air to convert it into nitrogen dioxide.

7. What I claim as my invention is: the process in claim 1 using concentrated sulfuric acid and concentrated (about 42%) sodium- or potassium nitrite solution; the chemicals brought together will start the chemical reactions that produce nitrogen dioxide, nitrogen oxide as major products, nitric acid, nitrogen oxide and sodium- or potassium sulfate as secondary products.

8. What I claim as my invention is: the process in claim 1 using concentrated sulfuric acid and solid salt of sodium- or potassium nitrite; the chemicals brought together will start the chemical reactions that produce nitrogen dioxide, nitrogen oxide as major products, nitric acid, nitrogen oxide and sodium or potassium sulfate as secondary products.

9. What I claim as my invention is: the process in claim 1 using concentrated sulfuric acid and solid salt of sodium- or potassium nitrite, the chemicals brought together will start the chemical reactions, then adding water to the reacting chemicals will speed up the ongoing chemical reactions that produce nitrogen dioxide, nitrogen oxide as major products, nitric acid, nitrogen oxide and sodium- or potassium sulfate as secondary products.

10. What I claim as my invention is: the process in claim 1 using concentrated nitric acid and concentrated (about 42%) sodium- or potassium nitrite solution; the chemicals brought together will start the chemical reactions that produce nitrogen dioxide, nitrogen oxide as major products, nitric acid, nitrogen oxide and sodium- or potassium nitrate as secondary products.

11. What I claim as my invention is: the process in claim 1 using concentrated nitric acid and solid sodium- or potassium nitrite, the chemicals brought together will start the chemical reactions that produce nitrogen dioxide, nitrogen oxide as major products, nitric acid, nitrogen oxide and sodium- or potassium nitrate as secondary products.

12. What I claim as my invention is: the process in claim 1 using concentrated phosphoric acid and concentrated (about 42%) sodium- or potassium nitrite solution; the chemicals brought together will start the chemical reactions that produce nitrogen dioxide, nitrogen oxide as major products, nitric acid, nitrogen oxide and sodium- or potassium phosphate as secondary products.

13. What I claim as my invention is: the process in claim 1-using concentrated phosphoric acid and solid sodium- or potassium nitrite; the chemicals brought together will start the chemical reactions that produce nitrogen dioxide, nitrogen oxide as major products, nitric acid, nitrogen oxide and sodium- or potassium phosphate as secondary products.

14. What I claim as my invention is: the process in claim 1 using concentrated hydrochloric acid and concentrated (about 42%) sodium- or potassium nitrite solution; the chemicals brought together will start the chemical reactions that produce nitrogen dioxide, nitrogen oxide as major products, nitric acid, nitrogen oxide and sodium- or potassium chloride as secondary products.

15. What I claim as my invention is: the process in claim 1 using concentrated hydrochloric acid and solid sodium- or potassium nitrite; the chemicals brought together will start the chemical reactions that produce nitrogen dioxide, nitrogen oxide as major products, nitric acid, nitrogen oxide and sodium- or potassium chloride as secondary products.

16. What I claim as my invention is: the process in claim 1 using 48% hydrobromic acid and concentrated (about 42%) sodium- or potassium nitrite solution; the chemicals brought together will start the chemical reactions that produce nitrogen dioxide, nitrogen oxide as major products, nitric acid, nitrogen oxide and sodium- or potassium bromide as secondary products.

17. What I claim as my invention is: the process in claim 1 using 48% hydrobromic acid and solid sodium- or potassium nitrite; the chemicals brought together will start the chemical reactions that produce nitrogen dioxide, nitrogen oxide as major products, nitric acid, nitrogen oxide and sodium- or potassium bromide as secondary products.

18. What I claim as my invention is: the process in claim 1 using from 38% to 70% hydroflouric acid and concentrated (about 42%) sodium- or potassium nitrite solution; the chemicals brought together will start the chemical reactions that produce nitrogen dioxide, nitrogen oxide as major products, nitric acid, nitrogen oxide and sodium- or potassium fluoride as secondary products.

19. What I claim as my invention is: the process in claim 1 using from 38% to 70% hydroflouric acid and solid sodium- or potassium nitrite; the chemicals brought together will start the chemical reactions that produce nitrogen dioxide, nitrogen oxide as major products, nitric acid, nitrogen oxide and sodium- or potassium fluoride as secondary products.

20. What I claim as my invention is: the process in claim 1 using 47% hydriodic acid and concentrated (about 42%) sodium- or potassium nitrite solution; the chemicals brought together will start the chemical reactions that produce nitrogen dioxide, nitrogen oxide as major products, nitric acid, nitrogen oxide, iodine as secondary products.

21. What I claim as my invention is: the process in claim 1 using 47% hydriodic acid and solid sodium- or potassium nitrite; the chemicals brought together will start the chemical reactions that produce nitrogen dioxide, nitrogen oxide as major products, nitric acid, nitrogen oxide, iodine as secondary products.

22. What I claim as my invention is: the process in claim 1 using iodine monochloride in liquid form and concentrated (about 42%) sodium- or potassium nitrite solution; the chemicals brought together will start the chemical reactions that produce nitrogen dioxide, nitrogen oxide as major products, nitric acid, nitrogen oxide, iodine and sodium hypochlorite as secondary products.

23. What I claim as my invention is: the process in claim 1 using 97% formic acid and concentrated (about 42%) sodium- or potassium nitrite solution; the chemicals brought together will start the chemical reactions that produce nitrogen dioxide, nitrogen oxide as major products, nitric acid, nitrogen oxide, sodium- or potassium formate as secondary products.

24. What I claim as my invention is: the process in claim 1 using concentrated (about 88%) formic acid and solid sodium- or potassium nitrite; he chemicals brought together will start the chemical reactions that produce nitrogen dioxide, nitrogen oxide as major products, nitric acid, nitrogen oxide, and sodium- or potassium formate as secondary products.

25. What I claim as my invention is: the process in claim 1 using 100% acetic acid and concentrated (about 42%) sodium- or potassium nitrite solution; the chemicals brought together will start the chemical reactions that produce nitrogen dioxide, nitrogen oxide as major products, nitric acid, nitrogen oxide, sodium- or potassium acetate as secondary products.

26. What I claim as my invention is: the process in claim 1 using 100% acetic acid and solid sodium- or potassium nitrite; the chemicals brought together will start the chemical reactions that produce nitrogen dioxide, nitrogen oxide as major products, nitric acid, nitrogen oxide, and sodium- or potassium acetate as secondary products.

27. What I claim as my invention is: the process in claim 1 using 100% propionic acid and concentrated (about 42%) sodium- or potassium nitrite solution; the chemicals brought together will start the chemical reactions that produce nitrogen dioxide, nitrogen oxide as major products, nitric acid, nitrogen oxide, sodium- or potassium propionate as secondary products.

28. What I claim as my invention is: the process in claim 1 using 100% butyric acid and concentrated (about 42%) sodium- or potassium nitrite solution; he chemicals brought together will start the chemical reactions that produce nitrogen dioxide, nitrogen oxide as major products, nitric acid, nitrogen oxide, sodium- or potassium butyrate as secondary products.

29. What I claim as my invention is: the process in claim 1 using liquid bromine and concentrated (about 42%) sodium- or potassium nitrite solution; the chemicals brought together will start the chemical reactions that produce nitrogen dioxide, nitrogen oxide as major products, nitric acid, nitrogen oxide, sodium- or potassium bromide as secondary products.

30. What I claim as my invention is: the process in claim 1 using liquid bromine and solid sodium- or potassium nitrite and adding water; will start the chemical reactions that produce nitrogen dioxide, nitrogen oxide as major products, nitric acid, nitrogen oxide, and sodium- or potassium bromide as secondary products.

31. What I claim as my invention is: the process in claim 1 and using concentrated (about 42%) sodium nitrite and potassium nitrite solutions or solid mixture of these compounds and brought them together with any of the second reactants (acids or halide compounds) in claim 7 to claim 30 will start the chemical reactions that produces nitrogen dioxide, nitrogen oxide as major products and sodium and potassium salts of the second reactants, and sometimes solid element(s), as iodine, as secondary products.

32. What I claim as my invention is: spraying the second reactant(s), usually the acid(s) on the surface of the nitrite solution pool or on the solid nitrite salt(s) helps the process of the chemical reactions to proceed and produce the desired products that can be produced by this physical method.
